(19) United States
(12) Patent Application Publication
(10) Pub. No.: US 2008/0107279 A1
(43) Pub. Date: May 8, 2008

(54) SOUND-PROCESSING DEVICE WITH AUTOMATIC HOWL CANCELLATION AND CANCELLING HOWL METHOD THEREOF

(75) Inventors: Shien-Neng Lai, Taipei County (TW); Ming-Ching Lin, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 11/623,118

(22) Filed: Jan. 15, 2007

(30) Foreign Application Priority Data
Nov. 7, 2006 (TW) 95141139

(51) Int. Cl. H04B 3/20

(52) U.S. Cl. 381/66

(57) ABSTRACT

The invention provides a sound-processing device with automatic howl cancellation. The sound-processing device includes an array microphone, a digital signal processor, a power amplifier, and a loudspeaker. The array microphone includes a plurality of microphones, receiving a sound wave at different locations and converting the sound wave to a plurality of audio signals, wherein the audio signals carry howl induced by a sound wave feedback. The digital signal processor includes a beam forming module and an acoustic echo cancellation module. The beam forming module derives a beam signal from the audio signals to suppress out-of-beam howl, and the acoustic echo cancellation module estimates and eliminates howl carried by the beam signal. The power amplifier then amplifies the beam signal subsequent to eliminating howl. Finally, the loudspeaker converts the amplified beam signal to an amplified sound wave.

### BACKGROUND OF THE INVENTION

1. Field of the Invention

The invention relates to sound-processing devices, and more particularly to howl cancellation of sound-processing devices.

2. Description of the Related Art

FIG. 1 shows a howl generating process of a sound-processing device 100. The sound-processing device 100 receives, amplifies and broadcasts a sound wave to obtain an amplified sound wave. In some embodiments, the sound-processing device 100 is a loudspeaker. The sound-processing device 100 includes a microphone 102, a power amplifier 104, and a loudspeaker 106. The microphone 102 receives a sound wave and converts the sound wave to an audio signal. The power amplifier 104 then amplifies the audio signal. The loudspeaker 106 then converts the amplified audio signal to an amplified sound wave for broadcast. Because the amplified sound wave is transmitted in all directions, a portion of the amplified sound wave is fed back to the microphone 102. The audio signal converted by the microphone 102 therefore comprises sound wave feedback, which is further amplified and broadcast. Because the sound wave feedback is recursively amplified, a harsh howl exists, deteriorating quality of the amplified sound wave. Thus, a method for canceling howl in sound-processing devices to thereby improve quality of the amplified sound wave is desirable.

A conventional solution to the aforementioned howl replaces the omni-directional microphone 102 of FIG. 1 with a unidirectional microphone. The uni-directional microphone can only receive a sound wave from a specific range of direction not affected by sound wave feedback, thus, mitigating the howl problem. Because the sound wave feedback spreads in all directions, however, the uni-directional microphone still receives a portion of the sound wave feedback, thus, howl cannot be completely removed by the uni-directional microphone.

There are still other methods for handling howl problems. FIG. 2 is a block diagram of a sound-processing device 200 capable of canceling howl. The sound-processing device 200 includes a microphone 202, a switch module 208, a power amplifier 204, and a loudspeaker 206. The switch module 208 can disconnect the microphone 202 from the power amplifier 204. When howl occurs, the sound-processing device 200 disconnects the microphone 202 from the power amplifier 204 with the switch module 208, and the power amplifier 204 does not amplify the sound feedback. The recursive amplification of the sound feedback is stopped, and howl is eliminated. The switch module 208, however, also blocks the amplification path of the audio signal and prevents the sound-processing device 200 from normally functioning. Thus, a method for canceling howl in a sound-processing device without affecting normal functions of the sound-processing device is desirable.

### BRIEF SUMMARY OF THE INVENTION

The invention provides a sound-processing device with automatic howl cancellation. An exemplary embodiment of a sound-processing device comprises an array microphone, a digital signal processor, a power amplifier, and a loudspeaker. The array microphone comprises a plurality of microphones. Each microphone receives a sound wave at different locations and converts the sound wave to a plurality of audio signals carrying howl induced by a sound wave feedback. The digital signal processor includes a beam forming module and an acoustic echo cancellation module. The beam forming module derives a beam signal from the audio signals to suppress out-of-beam howl, and the acoustic echo cancellation module estimates and eliminates howl carried by the beam signal. The power amplifier then amplifies the beam signal subsequent to eliminating howl. Finally, the loudspeaker converts the amplified beam signal to an amplified sound wave.

The invention also provides another sound-processing device with automatic howl cancellation. In this embodiment, the sound-processing device comprises a microphone, a digital signal processor, a power amplifier, and a loudspeaker. The microphone converts a sound wave to an audio signal, wherein the audio signal carries howl induced by a sound wave feedback. The digital signal processor includes an acoustic echo cancellation module estimating and eliminating howl carried by the audio signal. The power amplifier then amplifies the audio signal subsequent to eliminating howl. Finally, the loudspeaker then converts the amplified audio signal to an amplified sound wave.

The invention also provides a howl cancellation device installed in a sound-processing device. In this embodiment, the howl cancellation device comprises an analog to digital converter, a subtraction module, and a beam forming module, an acoustic echo cancellation module, and a digital to analog converter. The analog to digital converter converts a plurality of audio signals to a plurality of data streams, wherein the audio signals are derived from a sound wave received at different locations and carry howl due to a sound wave feedback. The subtraction module eliminates a howl estimated from the data streams. The beam forming module generates a beam signal coming from a certain direction according to the data streams to suppress out-of-beam howl. The acoustic echo cancellation module generates the howl estimate carried by the beam signal. The digital to analog converter converts the beam signal from digital form to analog form.

The invention also provides a method for canceling howl in a sound-processing device. First, a sound wave received at different locations is converted into a plurality of audio signals. A beam signal is then derived from the audio signals with a beam forming module of a digital signal processor to suppress out-of-beam howl An acoustic echo cancellation module of the digital signal processor then estimates the amount of how carried by the beam signal to obtain a howl estimate. Finally, the howl estimate is eliminated from the beam signal.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of howl generation of a sound-processing device;

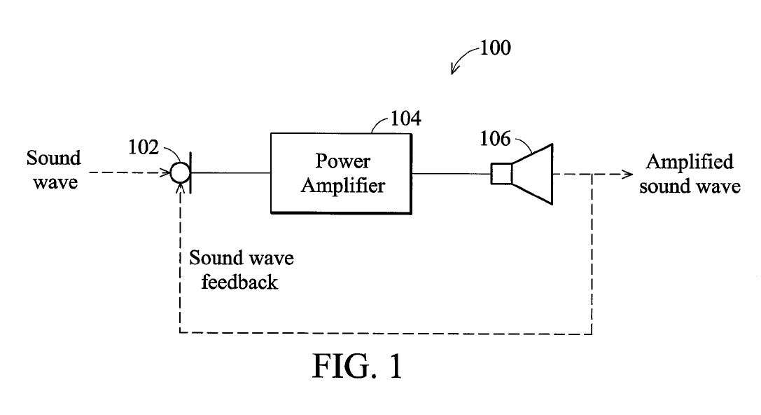

FIG. 2 is a block diagram of a sound-processing device capable o canceling howl;

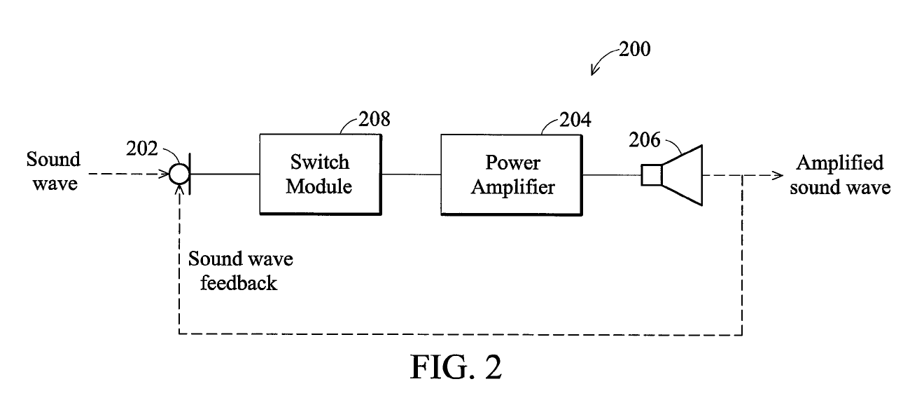

FIG. 3 is a block diagram of a sound-processing device with automatic howl cancellation according to the invention;

FIG. 4 is a block diagram of another sound-processing device with automatic howl cancellation according to the invention; and

FIG. 5 is a flowchart of a method for canceling howl in a sound-processing device according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

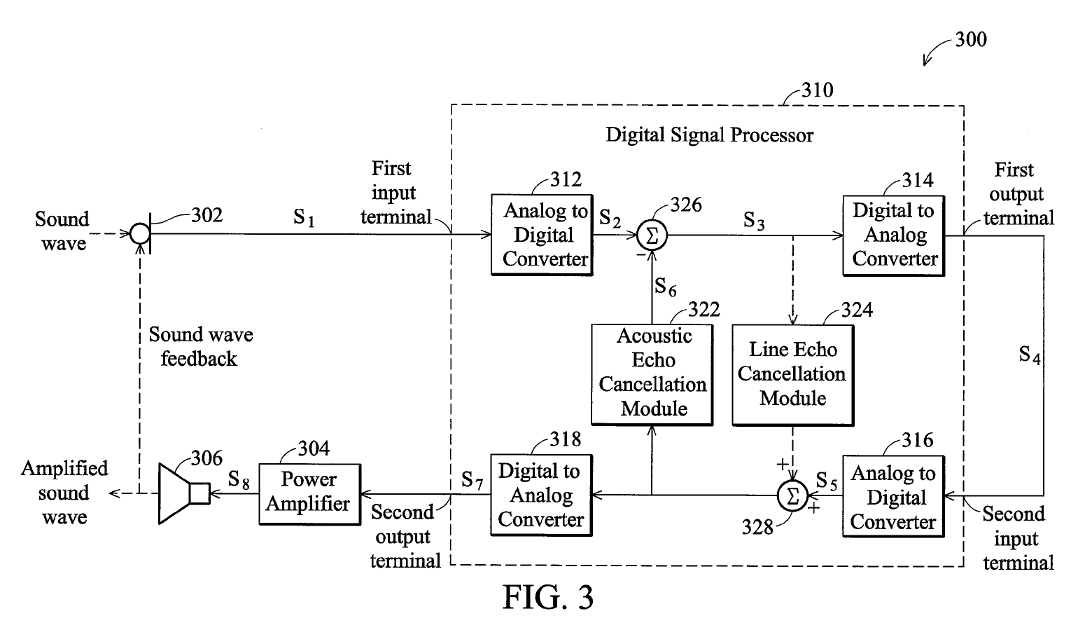

FIG. 3 is a block diagram of a sound-processing device 300 with automatic howl cancellation according to the invention. The sound-processing device 300 includes a microphone 302, a digital signal processor 310, a power amplifier 304, and a loudspeaker 306. The microphone 302 first converts a sound wave into an audio signal S₁. Because a portion of an amplified sound wave broadcast by the loud speaker is also fed back to the microphone 302, the audio signal S₁ comprises howl induced by the sound wave feedback. The audio signal S₁ is then delivered to the digital signal processor 310 for howl cancellation. The sound-processing module 300 eliminates howl from the audio signal S₁ with an acoustic echo cancellation module 322 of the digital signal processor 310, thus, an audio signal S7 without howl is obtained for amplification in the power amplifier 304.

The digital signal processor 310 includes analog to digital processors 312 and 316, digital to analog processors 314 and 318, an acoustic echo cancellation module 322, line echo cancellation module 324, and subtraction modules 326 and 328. There are two signal processing paths in the digital signal processor 310. In a first signal processing path, an audio signal is received by the digital signal processor 310 through a first input terminal, and then converted by the analog to digital converter 312 from an analog form to a digital form. Subsequent to further processing, the processed audio signal is converted by the digital to analog converter 314 back into an analog audio signal and output to a first output terminal. In the second signal processing path, an audio signal is received by the digital signal processor 310 through a second input terminal, and then converted by the analog to digital converter 316 from analog to digital. Subsequent to further processing, the processed audio signal is converted by the digital to analog converter 318 back into an analog audio signal and output to a second output terminal.

Two echo cancellation modules, the acoustic echo cancellation module 322 and the line echo cancellation module 324, are coupled between the first signal processing path and the second signal processing path. The acoustic echo cancellation module 322 estimates an acoustic echo between the first and the second signal processing path according to algorithms, such as a least-mean-square self-adaptive algorithm. The line-echo cancellation module 324 cancels a line echo due to mismatched impedance between signal transmitting paths.

The audio signal S₁ is first received by the digital signal processor 310 through the first input terminal. The analog audio signal S₁ is then converted by the analog to digital converter 312 into a data stream S₂. The subtraction module 326 then removes a howl estimate S₆ generated by the acoustic echo cancellation module 322 from the data stream S₂ to obtain a data stream S₃. Thus, the data stream S₃ carries less howl. The data stream S₃ is then converted by the digital to analog converter 314 into an analog audio signal S₄, which is output to the first output terminal.

Because the howl estimate S₆ is generated by the acoustic echo cancellation module 322 coupled between the first and the second signal processing paths, the audio signal S₄ must be fed back to the second signal processing path of the digital signal processor 310. After received through the second input terminal, the audio signal S₄ is first converted by the analog to digital converter 316 into a data stream S₅. The acoustic echo cancellation module 322 then estimates the howl carried by the data stream S₅ to obtain the howl estimate S₆, which is removed from the data stream S₂ by the subtraction module 326. Finally, the data stream S₅ is then converted by the digital to analog converter 318 into an analog audio signal S₇, which is output to the second output terminal. The line echo cancellation module 324, however, may take a common signal component between the data streams S₃ and S₅ as a line echo. To prevent the line echo cancellation module 324 from eliminating the data stream S₃ from the datastream S₅, the line echo cancellation module 324 is disabled for the duration of the whole howl cancellation process.

The power amplifier 304 then amplifies the audio signal S₇ to obtain an amplified audio signal S₈. The loudspeaker 306 then converts the amplified audio signal S₈ into an amplified sound wave for broadcast. Because the audio signal S₇ carries no howl, the amplified sound wave also carries no howl. Thus, even if the microphone 302 receives a portion of the amplified sound wave, the acoustic echo cancellation module 322 of the digital signal processor 310 again eliminates induced howl. According to practical experiment results, the acoustic echo cancellation module 322 attenuates howl by 30˜35 dB.

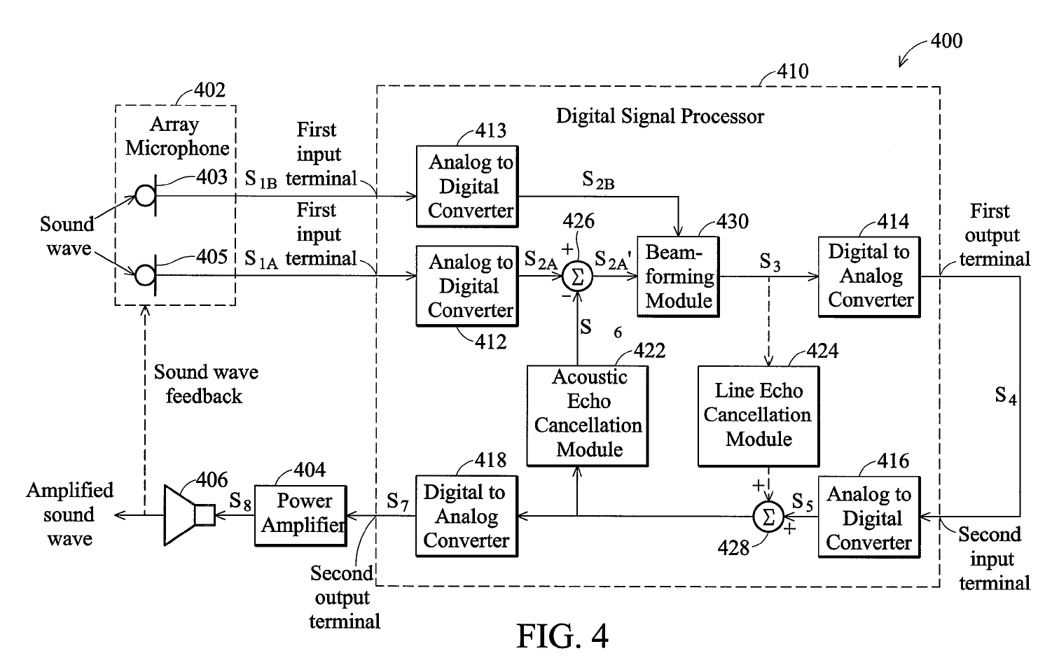

Although the sound-processing device 300 can automatically cancel a portion of howl, the howl attenuation rate is not adequate, resulting in a low howl attenuation speed. The invention therefore further uses an array microphone and a beam forming module of a digital signal processor for howl cancellation. FIG. 4 is a block diagram of another sound-processing device 400 with automatic howl cancellation according to the invention. The sound-processing device 400 is roughly similar to the sound-processing device 300 of FIG. 3, but further comprises an array microphone 402 and a beam forming module 430.

The array microphone 402 includes a plurality of microphones receiving a sound wave at different locations. In an embodiment, the array microphone 402 includes microphones 403 and 405, which respectively convert the sound wave to audio signals S_{1B} and S_{1A}. The audio signals S_{1B} and S_{1A} carry howl due to a sound wave feedback from the loudspeaker 406. Although the audio signals S_{1B} and S_{1A} are converted from the same sound wave, phases and amplitudes of the audio signals S_{1B} and S_{1A} are still slightly different because of the difference in received location. The audio signals S_{1B} and S_{1A} are then delivered to the digital signal processor 410 for howl cancellation.

Accordingly, there are two signal processing paths in the digital signal processor 410. First, the audio signals S_{1A} and S_{1B} are respectively converted by analog to digital converters 412 and 413 into data streams S_{2A} and S_{2B}. A subtraction module 426 then removes a howl estimate S₆ generated by an acoustic echo cancellation module 422 from the data stream S_{2A} to obtain a data stream S_{2A}′. Thus, the data stream S_{2A}′ carries less howl. The beam forming module 430 then generates a beam signal S₃ coming from a certain direction range according to the phase difference and the amplitude difference between the data streams S_{2A}′ and S_{2B}. Because the receiving direction of the beam signal departs from the receiving direction of the sound feedback, out-of-beam howl is further eliminated from the beam signal S₃. The beam signal S₃ is then converted by the digital to analog converter 414 into an analog beam signal S₄, which is output to the first output terminal.

The analog beam signal S₄ is then fed back to a second signal processing path of the digital signal processor 410 through a second input terminal. The analog beam signal S₄ is first converted by an analog to digital converter 416 into a digital beam signal S₅. An acoustic echo cancellation module 422 then estimates the howl carried by the beam signal S₅ to obtain the howl estimate S₆, which is removed from the data stream S_{2A} by the subtraction module 226. Finally, the digital beam signal S₅ is then converted by a digital to analog converter 418 into an analog beam signal S₇, which is output to a second output terminal. Accordingly, a line echo cancellation module 424 is disabled for the duration of the howl cancellation process.

The power amplifier 404 then amplifies the beam signal S₇ to obtain an amplified beam signal S₈. The loudspeaker 406 then converts the amplified beam signal S₈ into an amplified sound wave for broadcast. Because the beam signal S₇ carries no howl, the amplified sound wave also carries no howl. Thus, even if the array microphone 402 receives a portion of the amplified sound wave, the acoustic echo cancellation module 422 and beam forming module 430 of digital signal processor 410 eliminate induced howl again. According to practical experiment results, the acoustic echo cancellation module 422 attenuates howl by 30˜35 dB, and the beam forming module 430 further attenuates howl by 20 dB, increasing the howl attenuation speed of the sound-processing device 400.

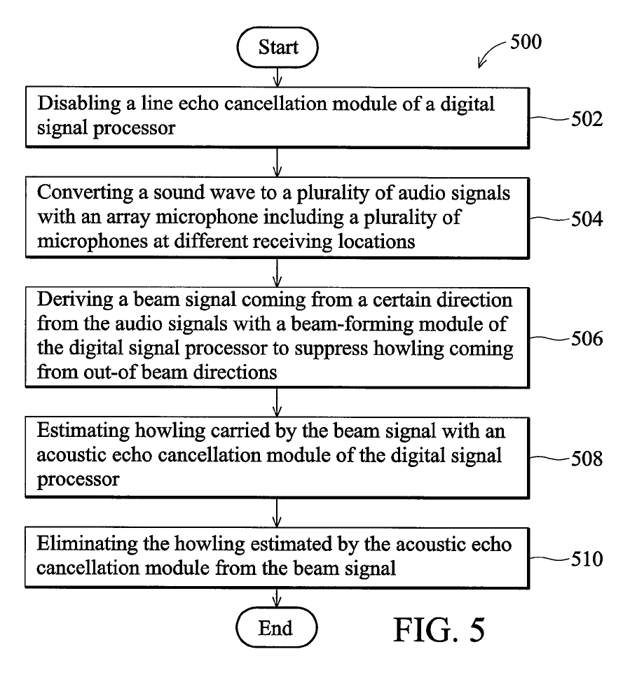

FIG. 5 is a flowchart of a method 500 for canceling howl in a sound-processing device according to the invention. First, a line echo cancellation module of a digital signal processor of the sound-processing device is disabled instep 502. In step 504 a sound wave is then received by an array microphone including multiple microphones at different locations, and converted to a plurality of audio signals. A beam forming module of the digital signal processor then derives a beam signal from the audio signals in step 506 to suppress out-of-beam howl. An acoustic echo cancellation module of the digital signal processor then estimates howl carried by the beam signal in step 508. The howl estimated by the acoustic echo cancellation module is then eliminated from the beam signal in step 510. Thus, because howl is twice removed in steps 506 and 510, the howl carried by the original audio signals is substantially attenuated.

The invention provides a sound-processing device with automatically howl cancellation. The sound-processing device includes an array microphone and a digital signal processor comprising a beam forming module and an acoustic echo cancellation module. Because howl is cancelled twice, by the beam forming module and the acoustic echo cancellation module, howl is substantially attenuated. Thus, the performance of the sound-processing device is improved.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A sound-processing device with automatic howl cancellation, comprising:
an array microphone, including a plurality of microphones, receiving a sound wave at different locations and converting the sound wave to a plurality of audio signals, wherein the audio signals carry howl induced by a sound wave feedback;
a digital signal processor, coupled to the array microphone, including a beam forming module and an acoustic echo cancellation module, wherein the beam forming module derives a beam signal from the audio signals to suppress out-of-beam howl, and the acoustic echo cancellation module estimates and eliminates howl carried by the beam signal;
a power amplifier, coupled to the digital signal processor, amplifying the beam signal subsequent to eliminating howl; and
a loudspeaker, coupled to the power amplifier, converting the amplified beam signal to an amplified sound wave.

2. The sound-processing device as claimed in claim 1, wherein the digital signal processor comprises:
a plurality of first analog to digital converters, converting the audio signals to a plurality of data streams;
a subtraction module, coupled to the first analog to digital converters, eliminating a howl estimate from the data streams;
the beam forming module, coupled to the first analog to digital converters and the subtraction module, generating the beam signal originating from a certain direction according to the data streams to suppress out-of-beam howl;
the acoustic echo cancellation module, coupled to the beam forming module, generating the howl estimate carried by the beam signal; and
a first digital to analog converter, coupled to the beam forming module, converting the beam signal from digital form to analog form.

3. The sound-processing device as claimed in claim 2, wherein the digital signal processor further comprises a line echo cancellation module, coupled between an output terminal of the beam forming module and an input terminal of the acoustic echo cancellation module, disabled during howl cancellation.

4. The sound-processing device as claimed in claim 2, wherein the acoustic echo cancellation module and the first digital to analog converter are not directly coupled to the beam forming module, and the digital signal processor further comprises:
a second digital to analog converter, coupled to the beam forming module, converting the beam signal from digital form to analog form and outputting the beam signal to an output terminal of the digital signal processor, wherein the output terminal of the digital signal processor is coupled with an input terminal of the digital signal processor; and
a second analog to digital converter, coupled to the input terminal of the digital signal processor, converting the beam signal from analog form to digital form and delivering the beam signal to the acoustic echo cancellation module and the first digital to analog converter.

5. A sound-processing device with automatic howl cancellation, comprising:
a microphone, converting a sound wave to an audio signal, wherein the audio signal carries howl induced by a sound wave feedback;
a digital signal processor, coupled to the microphone, including an acoustic echo cancellation module estimating and eliminating howl carried by the audio signal;
a power amplifier, coupled to the digital signal processor, amplifying the audio signal subsequent to eliminating howl; and
a loudspeaker, coupled to the power amplifier, converting the amplified audio signal to an amplified sound wave.

6. The sound-processing device as claimed in claim 5, wherein the digital signal processor comprises:
an analog to digital converter, converting the audio signal to a data stream;
a subtraction module, coupled to the analog to digital converter, eliminating a howl estimate from the data stream;
the acoustic echo cancellation module, coupled to the subtraction module, generating the howl estimate carried by the data stream; and
a digital to analog converter, coupled to the subtraction module, converting the datastream to the audio signal without howl.

7. The sound-processing device as claimed in claim 6, wherein the digital signal processor further comprises a line echo cancellation module, coupled between an output terminal of the subtraction module and an input terminal of the acoustic echo cancellation module, disabled during howl cancellation.

8. A howl cancellation device, installed in a sound-processing device, comprising:
an analog to digital converter, converting a plurality of audio signals to a plurality of data streams, wherein the audio signals are derived from a sound wave received at different locations, and the audio signals carry howl due to a sound wave feedback;
a subtraction module, coupled to the analog to digital converter, eliminating a howl estimate from the data streams;
a beam forming module, coupled to the analog to digital converter and the subtraction module, generating a beam signal originating from a certain direction according to the data streams to suppress out-of-beam howl;
an acoustic echo cancellation module, coupled to the beam forming module, generating the howl estimate carried by the beam signal; and
a digital to analog converter, coupled to the beam forming module, converting the beam signal from digital form to analog form.

9. The howl cancellation device as claimed in claim 8, wherein the sound-processing device comprises an array microphone including a plurality of microphones at different locations for generating the audio signals.

10. The howl cancellation device as claimed in claim 8, wherein the sound-processing device comprises:
a power amplifier, coupled to the howl cancellation device, amplifying the beam signal subsequent to eliminating howl; and
a loudspeaker, coupled to the power amplifier, converting the amplified beam signal to an amplified sound wave.

11. The howl cancellation device as claimed in claim 8, wherein the howl cancellation device further comprises a line echo cancellation module, coupled between an output terminal of the beam forming module and an input terminal of the acoustic echo cancellation module, disabled during howl cancellation.

12. A method for canceling howl in a sound-processing device, comprising:
converting a sound wave received at different locations to a plurality of audio signals;
deriving a beam signal from the audio signals with a beam forming module of a digital signal processor to suppress out-of-beam howl;
estimating howl carried by the beam signal with an acoustic echo cancellation module of the digital signal processor to obtain a howl estimate; and
eliminating the howl estimate from the beam signal.

13. The method as claimed in claim 12, wherein the method further comprises disabling a line echo cancellation module of the digital signal processor during howl cancellation.
